(19) United States
(12) Patent Application Publication
(10) Pub. No.: US 2015/0213450 A1
(43) Pub. Date: Jul. 30, 2015

(54) METHOD FOR DETECTING POTENTIALLY FRAUDULENT ACTIVITY IN A REMOTE FINANCIAL TRANSACTION SYSTEM

(71) Applicant: ValidSoft UK Limited, London (GB)

(72) Inventors: John Petersen, London (GB); Patrick Carroll, London (GB); Jonathan Mark Alford, London (GB); Daniel Thornhill, London (GB)

(21) Appl. No.: 14/418,218

(22) PCT Filed: Jul. 31, 2013
(86) PCT No.: PCT/GB2013/052038

§ 371 Date: Jan. 29, 2015

(30) Foreign Application Priority Data
Aug. 1, 2012 (GB) 1213692.5

(51) Int. Cl. G06Q 20/40; H04L 29/06

(52) U.S. Cl. CPC G06Q 20/4016; H04L 63/1466

(57) ABSTRACT

There is disclosed a method for detecting potentially fraudulent activity in a remote financial transaction system. The system comprises a client computing device configured for data communication with a financial services server via a data communications network. The client computing device is further configured to display a web page for receiving transaction information from a user and to communicate the received transaction information to the financial services server via the data communications network in order to effect the financial transaction. The method comprises, when transaction information is communicated to the financial services server by the client computing device, the client computing device additionally communicating meta data relating to the configuration of the web page to a configuration data server via the data communications network. The method further comprises the configuration data server comparing the received meta data to a stored template of meta data for the web page. On the basis of the comparison the configuration data server provides an indication of potentially fraudulent activity.

This invention relates to a method for detecting potentially fraudulent activity in a remote financial transaction system, in particular for detecting Man-in-the-Browser (MitB) attacks in an Internet banking system.

### BACKGROUND

Man-in-the-Browser (MitB) attacks comprise a number of techniques, including:
Transaction Data Manipulation;
Transaction Injection; and
Credential Harvesting

Transaction Data Manipulation refers to the situation where the user's browser software is manipulated to wait for the genuine customer to perform a transaction, such as Pay Anyone or Add Payee, and to alter the entered Account details to those of their own account. Whether the fraud works depends on the security techniques used by the bank as well as customer diligence.

Transaction Injection refers to the situation where the genuine customer logs onto their Internet banking interface and the user's browser software has been manipulated to secretly inject a transaction, such as Pay Anyone or Add Payee, and typically, in the case of two-factor authentication solutions, relies on further page manipulation and social engineering to cause the genuine customer to authorise the (unseen) transaction.

Credential Harvesting refers to the situation where the user's browser software has been manipulated to inject additional fields, typically on a Login web page, to gather secret user credential information for later use, potentially on another banking channel.

The first two techniques are attacks designed to steal money at that point in time, i.e. during the current browser session. The third technique is designed to harvest confidential information such as passwords or PI Ns for later fraudulent use on the Internet or other channels, such as phone banking. Therefore detecting and preventing a real-time attack will not prevent losses occurring in a future attack where credentials have been stolen.

Techniques and methods used to identify or prevent MitB attacks include:
Browser lockdown software;
Hardware signing tokens; and
Out-of-Band transaction verification.

These three techniques all have various advantages and disadvantages. The first has usability and portability issues, is resource intensive and typically provides no form of user authentication. The second requires physical, expensive devices, is prone to error and user dissatisfaction and is limited in the number and types of transactions that can be protected. The third, whilst being the most flexible in terms of being able to protect any number, length and type of transaction, requires a phone call or SMS which incurs an incremental cost.

The first technique (lockdown) theoretically prevents all three aforementioned MitB vectors while the latter two do not prevent credential harvesting.

This invention, at least in its presently preferred embodiments, seeks to prevent or detect all three MitB techniques, as well as preventing users inadvertently authorising fraudulent transactions through inattention, for example by not reading transaction details sent via an SMS message and authorising the transaction regardless.

### BRIEF SUMMARY OF THE DISCLOSURE

According to a first aspect of the present invention there is provided a method for detecting potentially fraudulent activity in a remote financial transaction system, the system comprising a client computing device configured for data communication with a financial services server via a data communications network, the client computing device being further configured to display a web page for receiving transaction information from a user and to communicate the received transaction information to the financial services server via the data communications network in order to effect the financial transaction, the method comprising: when transaction information is communicated to the financial services server by the client computing device, the client computing device additionally communicating meta data relating to the configuration of the web page to a configuration data server via the data communications network; the configuration data server comparing the received meta data to a stored template of meta data for the web page; and on the basis of the comparison the configuration data server providing an indication of potentially fraudulent activity.

Thus, in accordance with the present invention, if the web page has been manipulated in an attempt to achieve a fraudulent transaction or to obtain the user's authentication information, a comparison of the meta data to the stored template will identify the potentially fraudulent activity.

According to a second aspect of the present invention there is provided a method of operating a client computing device in a remote financial transaction system, the system further comprising a financial services server and the client computing device being configured for data communication with the financial services server via a data communications network, the method comprising: displaying a web page for receiving transaction information from a user; communicating the received transaction information to the financial services server via the data communications network in order to effect the financial transaction; and additionally communicating meta data relating to the configuration of the web page to a configuration data server via the data communications network.

According to a third aspect of the present invention there is provided a method of operating a configuration data server, the method comprising: receiving meta data relating to the configuration of a web page from a client computing device; comparing the received meta data to a stored template of meta data for the web page; and on the basis of the comparison, providing an indication of potentially fraudulent activity; wherein the client computing device is in a remote financial transaction system, the system further comprising a financial services server and the client computing device being configured for data communication with the financial services server via a data communications network, the client computing device being further configured to display the web page for receiving transaction information from a user and to communicate the received transaction information to the financial services server via the data communications network in order to effect the financial transaction.

According to a fourth aspect of the present invention there is provided a client computing device in a remote financial transaction system, the system further comprising a financial services server and the client computing device being configured for data communication with the financial services server via a data communications network, the client computing device being configured to: display a web page for receiving transaction information from a user; communicate the received transaction information to the financial services server via the data communications network in order to effect the financial transaction; and additionally communicate meta data relating to the configuration of the web page to a configuration data server via the data communications network.

The client computing device may be a personal computer, a laptop computer, a tablet computer, a smartphone, a smart television or any other computing device capable of providing the necessary user interface.

According to a fifth aspect of the present invention there is provided a browser plug-in arranged, when installed upon a general-purpose computing device running a web browser, to configure the general-purpose computing device to operate as a client computing device as defined above.

According to a sixth aspect of the present invention there is provided a configuration data server configured to: receive meta data relating to the configuration of a web page from a client computing device; compare the received meta data to a stored template of meta data for the web page; and on the basis of the comparison, provide an indication of potentially fraudulent activity; wherein the client computing device is in a remote financial transaction system, the system further comprising a financial services server and the client computing device being configured for data communication with the financial services server via a data communications network, the client computing device being further configured to display the web page for receiving transaction information from a user and to communicate the received transaction information to the financial services server via the data communications network in order to effect the financial transaction.

According to a seventh aspect of the present invention there is provided a system comprising: a client computing device as defined above; a configuration data server as defined above; and a financial services server configured to receive the transaction information from the client computing device and to receive the indication of potentially fraudulent activity from the configuration data server.

There is further disclosed herein a method for detecting potentially fraudulent activity in a remote financial transaction system. The system comprises a client computing device configured for data communication with a financial services server via a data communications network. The client computing device is further configured to provide a user interface for receiving transaction information from a user and to communicate the received transaction information to the financial services server via the data communications network in order to effect the financial transaction. The method comprises, when transaction information is communicated to the financial services server by the client computing device, the client computing device additionally communicating data relating to the configuration of the user interface to a configuration data server via the data communications network. The method further comprises the configuration data server comparing the received configuration data to a stored template of configuration data for the configuration data. On the basis of the comparison the configuration data server provides an indication of potentially fraudulent activity.

The user interface may be an application (or app) running on the client computing device. Typically, however, the user interface is a web page. The client computing device may run a web browser to display the web page. In this case, the configuration data may be communicated to the configuration data server by a browser plug-in, or similar client plug-in, running on the client computing device.

The configuration data may be meta data from the web page. The meta data provides an indication of the construction of the web page in order that any modification to the web page can be identified by a comparison with the stored configuration (meta) data template.

Typically, the data communications network is the Internet. However, it is also possible to for the client computing device to communicate with the financial services server and/or the configuration data server via a private data communications network.

The configuration data server and the financial services server may be physically separate servers, which may be mutually remote. The configuration data server may be in data communication with the financial services server via the data communication network. However, in embodiments of the invention the financial services server may comprise the configuration data server.

Typically, the configuration data server communicates the indication to the financial services server. In this way, the financial services server can determine whether or not to process the transaction. The indication may be simply a value indicative of the likelihood of fraudulent activity. The financial services server may use additional information to determine whether or not to process the transaction.

The configuration data may be communicated from the client computing device directly to the configuration data server. Alternatively, the configuration data may be communicated from the client computing device to the configuration data server via the financial services server.

The transaction information may comprise at least authentication information for the user. The transaction information may comprise only authentication information for the user. In this case, the method will identify a potential fraudster attempting to obtain the user's authentication information. The authentication information may comprise a username, password, personal identification number (PIN) or the like. The authentication information may also comprise information received from the financial services server or an authentication, for example by means of a communication channel other than the data communications network (out-of-band authentication). In addition or alternatively, the transaction information may include financial information such as a payee account number and a transaction value.

### BRIEF DESCRIPTION OF THE DRAWINGS

Embodiments of the invention are further described hereinafter with reference to the accompanying drawings, in which:

FIG. 1 is a schematic representation of a financial transaction system for carrying out the method of the invention.

### DETAILED DESCRIPTION

A financial transaction system operating in accordance with an embodiment of the invention enables the detection, prevention and early warning of Man-in-the-Browser (MitB) attacks using an in-band solution, i.e. a solution using the communication channel on which the user is communicating transaction information, that can detect the presence of MitB software operating against any specific domain or pages within a domain on any given computer or smartphone.

An embodiment of the invention provides an in-band method of detecting the fraudulent alteration or injection of transactional content, e.g. account numbers or page (HTML) content, such as a password field by comparing meta data elements associated with the submitted page with pre-learnt and stored meta data elements or domain page templates. Further, when a MitB meta data element is detected and determined to be performing transaction data manipulation or transaction injection, the method of the invention can additionally detect the values of those data elements or, in the case of manipulation, detect both the legitimate and fraudulent values.

Lastly, when an MitB attack is detected the configuration data server can alert a banking application on the financial services server to either stop the transaction in progress and take further action (transaction data manipulation and transaction injection) or to block account access (credential harvesting) because an attack on the account may be imminent.

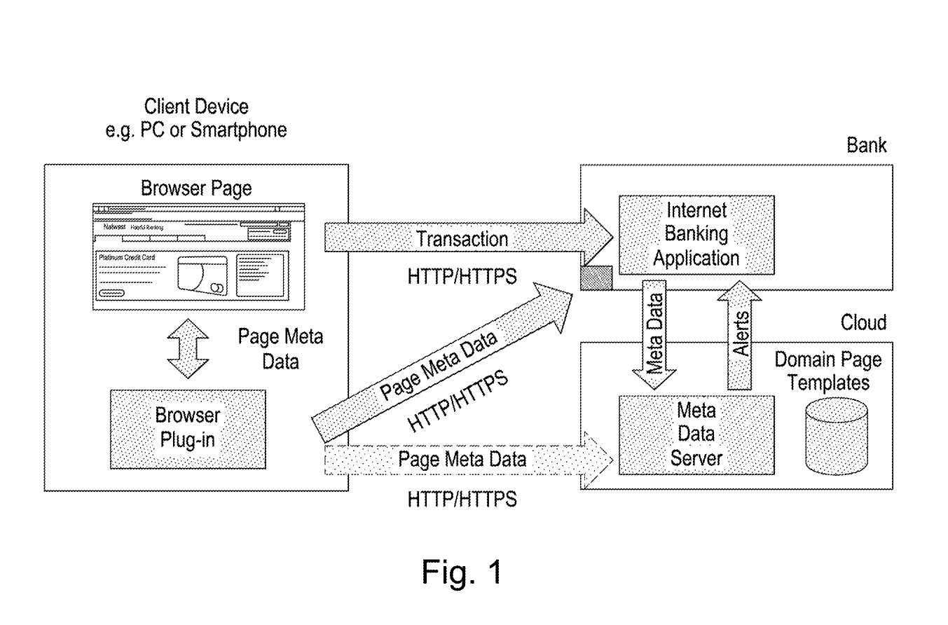

As shown in FIG. 1, the system according to the present invention comprises both client and server software components. The client computing device, which may be for example a personal computer or smartphone, comprises a web browser for accessing an Internet banking application provided by a financial services server at a bank. A browser plug-in is provided that is downloaded onto the client computing device whenever the domain or pages within the domain of the banking application are loaded. The browser plug-in collects meta data from the web page accessed by the browser on the client computing device and communicates the meta data either directly to a meta data server or to the banking application. A plug-in is provided to the server-based banking application to pass the collected meta-data and transaction data to the meta data server for processing (if the meta data is not communicated directly to the meta data server by the client computing device).

The browser plug-in captures all page meta data and optionally transaction data and transmits these back to the plug-in on the bank's server-based Internet banking application. The server-based plug-in then transmits this same information to the meta data server. This meta data server may be “cloud” based, software-as-a-service-based at a known location or in-house located within the bank.

Alternatively, as shown by the dashed arrow, the client browser plug-in can transmit the meta data and optionally transaction data directly to the meta data server rather than via the plug-in on the Internet banking application.

The meta data server then compares the meta data for the page with a template it has previously learnt for the relevant web page and which is held in a domain page datastore. Where the meta data server detects an anomaly with the page, it sends an alert to the bank's server-based Internet banking application along with any relevant transaction data corresponding to the anomaly. For instance, if the meta data server suspects Transaction Data Manipulation through the detection of a meta data anomaly on the account number field, it alerts the bank to halt the transaction and also pass back both the account number as entered by the genuine customer and the account number as entered by the manipulated browser software. Alternatively the bank's systems may call out to the meta data server post transaction to see if the meta data server detected any potential fraudulent activity on the session.

If the meta data server identifies Credential Harvesting it will alert the bank to the fact that the account is at risk of unauthorised access and potential fraud along with the fields used for harvesting and optionally the data actually harvested. Alternatively the bank's systems may call out to the meta data server post transaction to see if the meta data server detected any potential fraudulent activity on the session.

The browser plug-in can transmit information identifying the customer, where available, i.e. if the customer has entered unique identifying information, or alternatively (or in addition) can transmit the IP address of the connection or a session ID. Additionally, the meta data server can maintain an IP address black-list of known, infected machines.

The browser plug-in may additionally continuously alter its manifestation to avoid a MitB learning and circumventing the plug-in, for example by changing one or more of its operational parameters.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for detecting alteration of a web page in a remote financial transaction system, the system comprising a client computing device configured for data communication with a financial services server via the Internet, the method comprising:
the client computing device running a web browser to display a web page for receiving transaction information from a user;
the client computing device communicating the received transaction information to the financial services server via the Internet in order to effect a financial transaction;
when transaction information is communicated to the financial services server by the client computing device, the client computing device additionally communicating meta data relating to the configuration of the web page to a configuration data server via the Internet;
the configuration data server comparing the received meta data to a stored template of meta data for the web page; and
on the basis of the comparison the configuration data server determining whether the web page has been altered, and if the configuration data server determines that the web page has been altered, providing an indication that the web page has been altered.

2-3. (canceled)

4. A method as claimed in claim 1, wherein the financial services server comprises the configuration data server.

5. A method as claimed in claim 1, wherein the configuration data server communicates the indication to the financial services server.

6. A method as claimed in claim 5, wherein the configuration data server is in data communication with the financial services server via the Internet.

7. A method as claimed in claim 5, wherein the meta data is communicated from the client computing device to the configuration data server via the financial services server.

8. A method as claimed in claim 1, wherein the transaction information comprises at least authentication information for the user.

9. A method of operating a client computing device in a remote financial transaction system, the system further comprising a financial services server and the client computing device being configured for data communication with the financial services server via the Internet, the method comprising:
running a web browser to display a web page for receiving transaction information from a user;
communicating the received transaction information to the financial services server via the Internet in order to effect a financial transaction; and
when transaction information is communicated to the financial services server, additionally communicating meta data relating to the configuration of the web page to a configuration data server via the Internet.

10. A method of operating a configuration data server, the method comprising:
receiving meta data relating to the configuration of a web page from a client computing device;
comparing the received meta data to a stored template of meta data for the web page; and
on the basis of the comparison, determining whether the web page has been altered, and if the configuration data server determines that the web page has been altered, providing an indication that the web page has been altered.

11. A client computing device in a remote financial transaction system, the system further comprising a financial services server, and the client computing device being configured for data communication with the financial services server via the Internet, the client computing device being configured to:
run a web browser to display a web page for receiving transaction information from a user;
communicate the received transaction information to the financial services server via the Internet in order to effect a financial transaction; and
when transaction information is communicated to the financial services server, additionally communicate meta data relating to the configuration of the web page to a configuration data server via the Internet.

12. Computer software arranged, when installed upon a general-purpose computing device running a web browser, to configure the general-purpose computing device to operate as a client computing device as claimed in claim 11.

13. A configuration data server configured to:
receive meta data relating to the configuration of a web page from a client computing device;
compare the received meta data to a stored template of meta data for the web page; and
on the basis of the comparison, determine whether the web page has been altered and if the configuration data server determines that the web page has been altered, provide an indication that the web page has been altered.

14. A system comprising:
a client computing device as claimed in claim 11, wherein
a financial services server configured to receive the transaction information from the client computing device and to receive the indication that the web page has been altered from the configuration data server.

15. A system as claimed in claim 14 wherein the financial services server is further configured to provide web page data to the client computing device to enable the client computing device to display the web page.
